(19) United States
(12) Patent Application Publication
(10) Pub. No.: US 2010/0147459 A1
(43) Pub. Date: Jun. 17, 2010

(54) METHOD AND DEVICE FOR MELTING A THERMOPLASTIC, PARTICULARLY FOR WELDING PLASTIC PARTS

(76) Inventors: Joachim Nathrop, Dettingen (DE); Ralf Bauer, Schlat (DE)

Correspondence Address: KF ROSS PC, 5683 RIVERDALE AVENUE, SUITE 203 BOX 900, BRONX, NY, 10471-0900, US

(21) Appl. No.: 12/601,099

(22) PCT Filed: Apr. 25, 2008
(86) PCT No.: PCT/EP2008/003342

§ 371 Date: Nov. 20, 2009

(30) Foreign Application Priority Data
Jun. 4, 2007 (DE) 102007026163.4

(51) Int. Cl. B29C 65/10; B29B 13/02

(52) U.S. Cl. 156/304.6; 264/80; 425/143

(57) ABSTRACT

The invention relates to a method for melting a thermoplastic plastic material, particularly for welding plastic parts, wherein the plastic is heated by means of heat radiation via a radiation body (4) and simultaneously by the application of a hot gas, wherein the invention provides for the radiation body (4) to be heated on the interior thereof by burning a combustion gas, and for the exhaust resulting from the burning to be applied to the plastic material.

The invention relates to a method of and an apparatus for melting a thermoplastic, particularly for welding plastic parts, wherein the plastic is heated by a radiator by radiation and simultaneously by the application of a hot gas via convection.

As is known, when welding plastic parts, the surfaces of two parts to be connected are heated to a joining temperature, at which the plastic is melted, and the heated surfaces are subsequently joined under pressure. Various physical possibilities are utilized for melting the plastic along the welding line: heat conduction, internal and external friction, convection, and/or radiation. In order to fuse the plastic parts to be welded the plastic must be in a plastic state during joining.

A generic method and apparatus is known from EP 1 415 789 where the plastic parts to be melted are heated by radiation and a hot gas is simultaneously applied. Either heated air or an inert gas such as nitrogen or another inert gas are utilized as the hot gas supplied to the plastic through openings in the radiator. The heating of the gas is carried out by heating elements, such as heating wires, or heating cartridges.

The object of the invention is to provide a method of and an apparatus of the above type in which energy is utilized in a very efficient manner.

The object is attained by the characteristics of patent claim 1 and patent claim 4.

The dependent claims contain preferred, particularly advantageous embodiments of the invention.

Below, the invention is explained with reference to on an embodiment illustrated in a simplified manner. Therein:

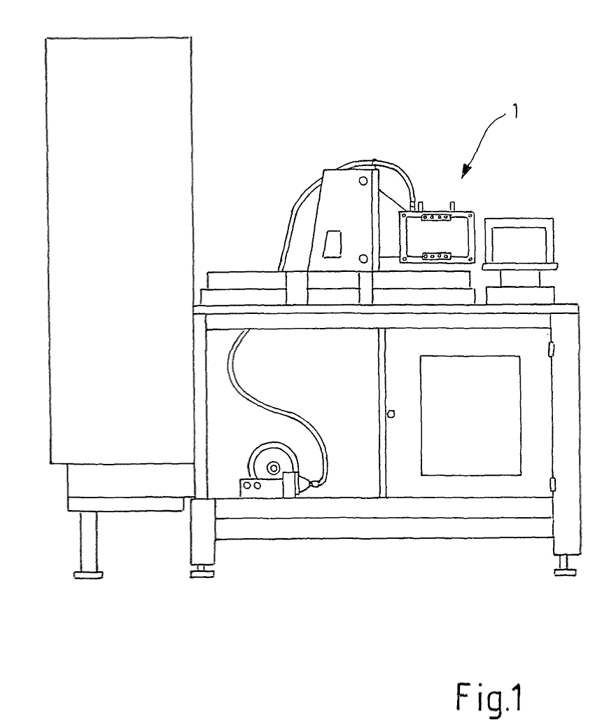

FIG. 1 is a side view of a welder having the apparatus according to the invention,

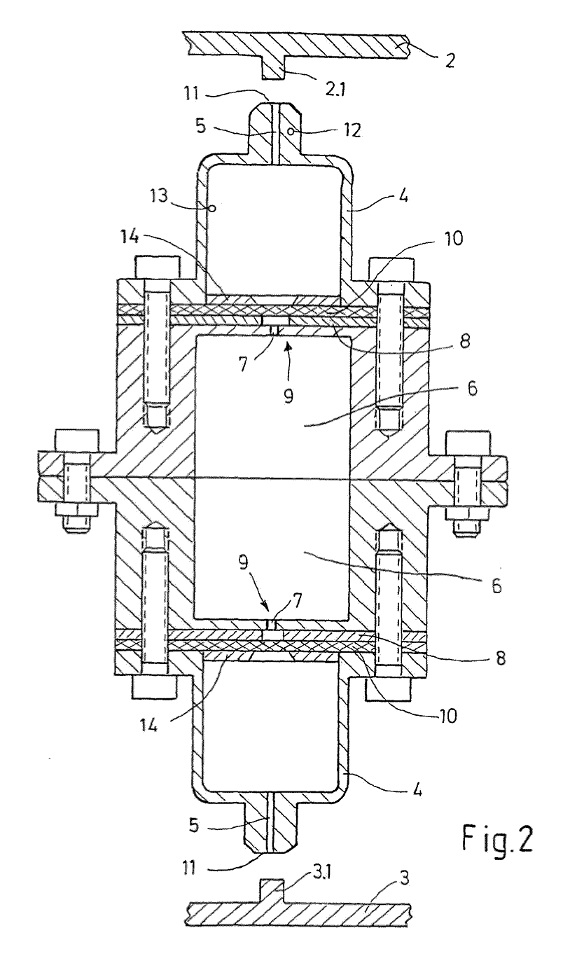

FIG. 2 is a section through an apparatus according to the invention,

FIG. 3 is a perspective view of the embodiment according to FIG. 2,

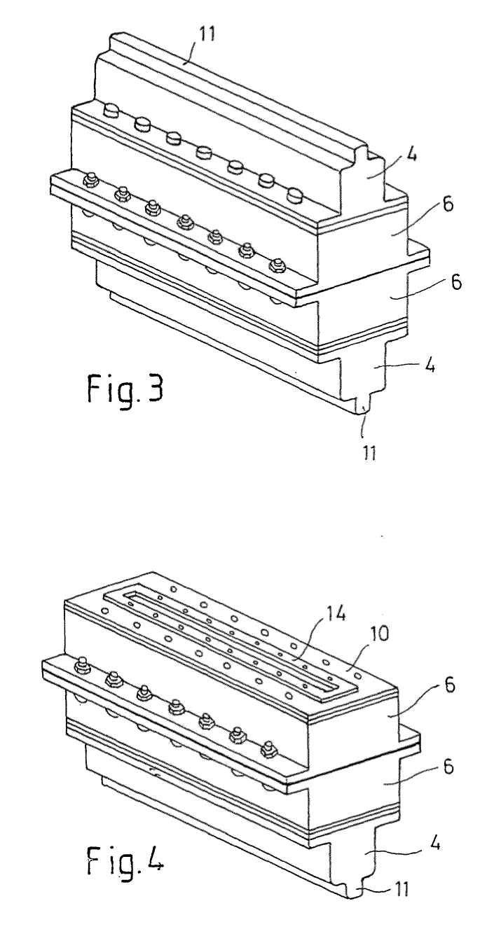

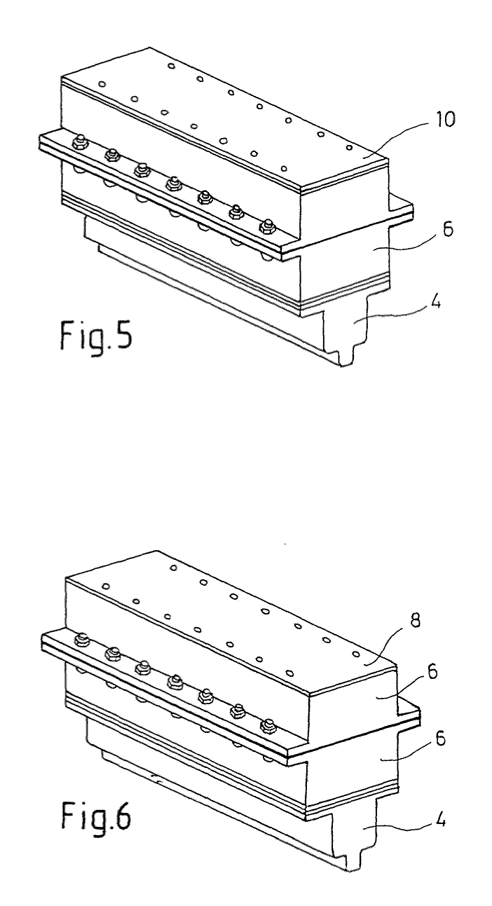

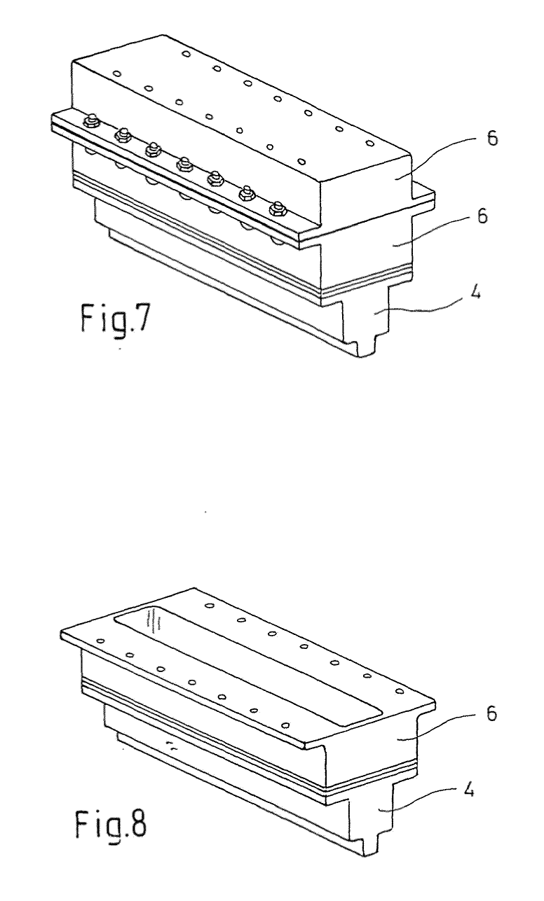

FIGS. 4-8 show the construction of the apparatus according to FIG. 2,

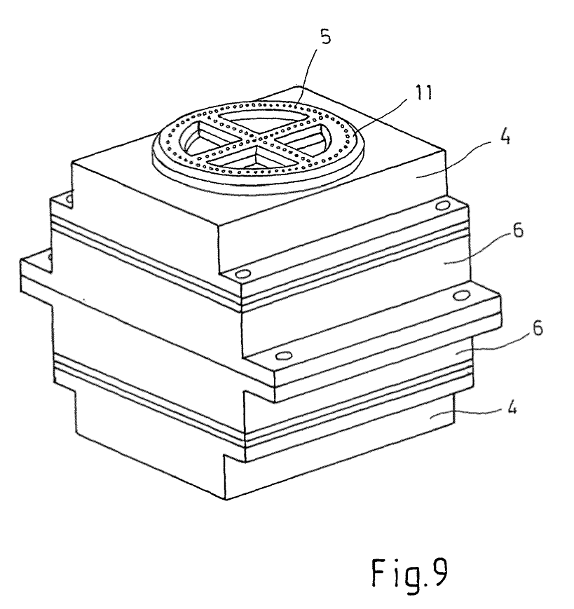

FIG. 9 is a perspective view of an alternative apparatus serving to melt a flat part.

As shown in FIG. 1 the apparatus 1 for melting plastic is part of a welder for welding plastic parts indicated at 2 and 3 in FIG. 2. As in known heater-type welders, the surfaces of two plastic parts 2 and 3 to be connected are heated to a bonding temperature by the apparatus 1, the plastic of both being plastified along the welding line. The heated surfaces are subsequently bonded together under pressure.

The apparatus shown in a perspective view in FIGS. 3 to 8 serves for heating straight-line, elongated, and narrow joint surfaces 2.1 and 3.1 on the plastic parts 2 and 3. The apparatus has at least one tubular radiator 4 that is heated internally by burning a combustion gas, and the exterior surface of which radiates combustion heat. Each radiator 4 has combustion-gas outlets 5 directed toward the joint surface of the respective plastic part 2 or 3.

In order to heat both plastic parts 2 and 3 the apparatus has two connected-together radiators 4 with the exhaust outputs 5 directed oppositely away from each other. Preferably, both radiators 4 are configured and arranged mirror-symmetrically to each other and have a common supply passage 6 for the combustion gas, preferably a gas/air mixture. The outer shape of the radiators 4 and the exhaust outlets 5 are configured in a manner to conform to the heated joint surfaces of the plastic parts 2 and 3.

In the embodiment according to FIG. 2 each part of the apparatus has a respective combustion-gas supply passage 6, both passages closing each other during assembly of the two parts such that a common supply passage 6 is created in which the supplied combustion gas is uniformly distributed. Each passage 6 has along its floor a row of gas-outlet orifices 7 covered by a seal 8. A foraminous fleece 10 lies on the outer face of each seal 8 and in turn is covered by a plate 14. The seal 8, the fleece, and the cover plate 14 also have openings so that the outlets 7 are not blocked. The outlets 7, the seals 8, the fleeces 10, and the cover plates 14 thus form a burner 9 whose flame and exhaust chamber is inside the radiator 4. To this end the fleece 10 ensures that the combustion gas in the burner 9 burns very uniformly.

The exhaust side the burner 9 is closed by the tubular radiator 4 such that any exhaust is conducted toward the exterior through the radiator 4 and subsequently vented through the outlets 5. Each radiator 4 is heated internally by the respective burner 9 such that its outer surface radiates and emits heat to the respective plastic part 2 or 3.

At the beginning of the heating process the combustion gas is ignited by an ignitor. It burns evenly in the burner 9 on the fleece 10. The burner 9 is operated such that the radiator 4 is strongly heated and radiates heat from its outer surface. The radiation heat is radiated to the joint respective surface 2.1 or 3.1 of the respective plastic part 2 or 3 from the respective configured outer face 11 of the radiator 4. The exhaust created in the burners 9 is collected inside the tubular radiators 4, subsequently exits through the outlets 5 and impinges upon the joint surfaces 2.1 and 3.1. For this purpose the hot outer face 11 of the radiator 4 and the outlets 5 are configured and arranged such that they are of the same shape as the joint surfaces 2.1 and 3.1 to be heated.

In order to control the melting process a temperature sensor 12 is provided at the hot outer face 11 of the radiator 4 to measure the temperature of this surface 11. The burner 9 is operated by the sensor 12 such that the desired temperature of the radiation surface 11 is adjusted accordingly. Preferably, a second temperature sensor 13 is provided inside the radiator 4 to measure the exhaust-gas temperature. In this manner the burner 9 may be regulated or controlled such that the desired exhaust temperature or temperature on the surface 11 can be adjusted accordingly.

The joint surface 2.1, 3.1 of the plastic parts 2 and 3 can be selectively fused by the hot exhaust and by the radiation heat radiated from the radiator 4 in this manner.

Preferably, the gas/air combustion mixture is adjusted such that the oxygen content in the exhaust is at a minimum. In this manner the exhaust simultaneously acts as inert gas during heating of the plastic parts 2 and 3. This reduces or even prevents the creation of oxygen compounds on the surface of the plastic during heating.

As previously mentioned, the shape of the radiator 4 conforms to that of the plastic parts 2 and 3 to be heated. If certain areas of a plastic part 2 and 3 that are radiantly or convectively heated are not to be heated, they are provided with shields. The shields are mounted on the outside of the radiator 4 at the respective locations and prevent any improper heating of areas of the plastic parts 2 and 3.

FIG. 9 shows an embodiment serving for melting a planar plastic part. The radiating outer face 11 of the radiator 4 is shaped as a circle on the outside, and in the shape of a cross in the center. A plurality of outlets 5 for the exhaust resulting from the burning is arranged within the hot outer face 11. The shape of the parts to be welded is indicated as a circle and as a cross in this example. Any other shape corresponding to the shape of the welded seam may also be employed. The outlets 5 are arranged according to the shape of the welded seam.

1. (canceled)

2. The method according to claim 13, wherein the combustion exhaust is fed to the thermoplastic through a plurality of the outlets in the radiator.

3. The method according to claims 13 wherein a mixture of the combustion gas is adjusted such that an oxygen content in the exhaust gas is at a minimum.

4. (canceled)

5. The apparatus according to claim 14 wherein an outer shape of the radiator is configured in a manner that conforms at least partially to a shape of the plastic part to be heated.

6. The apparatus according to claim 5 wherein the hot outer face of the radiator is configured in a manner that conforms to a joint surface of the plastic part.

7. The apparatus according to claim 14, further comprising
a temperature sensor for measuring the temperature of the hot outer face of the radiator.

8. The apparatus according to claim 14, further comprising
a temperature sensor for measuring the exhaust-gas temperature inside the radiator.

9. The apparatus according to claim 14, further comprising
shields mounted on the surface of the radiator to prevent an improper heating of certain areas of the plastic parts.

10. The apparatus according to claim 14 wherein the apparatus has two such radiators that are arranged opposite of each other and that each have a respective burner.

11. (canceled)

12. A method of welding two plastic parts, the method comprising the steps of:
burning a gas inside each of a pair of radiators so as to heat an outer face of the radiator and create hot exhaust gas inside the radiators;
juxtaposing each of the plastic parts with a respective one of the outer faces to radiantly heat regions of the parts;
exhausting the hot exhaust gas through outlets in each of the faces to direct respective streams of the hot exhaust gas at the parts to convectively heat and fuse the regions thereof; and
pressing together the fused regions.

13. A method of melting a thermoplastic, the method comprising the steps of:
burning a combustion gas inside a radiator so as to heat an outer face of the radiator and create hot exhaust gas inside the radiator;
juxtaposing the thermoplastic with the outer faces to radiantly heat a surface of the thermoplastic; and
exhausting the hot exhaust gas through an outlets in the outer face to direct a stream of the hot exhaust gas at the surface of the part to convectively heat and fuse the surface.

14. An apparatus for melting a thermoplastic, the apparatus comprising:
a radiator having a generally closed internal chamber and an outlet extending from the chamber and opening at an outer face of the radiator; and
means for supplying and burning a gas in the chamber so as to heat the outer face of the radiator and create a hot exhaust gas in the chamber that flows therefrom through the outlet onto a surface of the thermoplastic.
